(19) United States
(12) Patent Application Publication
(10) Pub. No.: US 2019/0061127 A1
(43) Pub. Date: Feb. 28, 2019

(54) Flange Manipulating Device

(71) Applicant: Matthew Cain, Hurst, TX (US)

(72) Inventor: Matthew Cain, Hurst, TX (US)

(21) Appl. No.: 15/692,629

(22) Filed: Aug. 31, 2017

(51) Int. Cl. B25B 27/16; F16L 23/12; B25B 23/00

(52) U.S. Cl. CPC B25B 27/16; B25B 23/0007; F16L 23/12

(57) ABSTRACT

A flange manipulating device for installing and removing flanges includes a bar that is flat. Each of a pair of first holes that is positioned through the bar is positioned proximate to a respective opposing end of the bar. A coupler is coupled to and centrally positioned on the bar. Each first hole is configured to selectively align with a respective second hole that is positioned in a flange. The first hole and the respective second hole are configured to insert hardware, such as a bolt to couple to a nut, to couple the bar to the flange. The coupler is configured to couple to a tool, such as a wrench, to position the tool to selectively applying torque to the bar. The bar is configured to transfer the torque from the tool to the flange to selectively install the flange on and remove the flange from a threaded pipe.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to manipulating devices and more particularly pertains to a new manipulating device for installing and removing flanges.

### BRIEF SUMMARY OF THE INVENTION

An embodiment of the disclosure meets the needs presented above by generally comprising a bar that is flat. Each of a pair of first holes that is positioned through the bar is positioned proximate to a respective opposing end of the bar. A coupler is coupled to and centrally positioned on the bar. Each first hole is configured to selectively align with a respective second hole that is positioned in a flange. The first hole and the respective second hole are configured to insert hardware, such as a bolt to couple to a nut, to couple the bar to the flange. The coupler is configured to couple to a tool, such as a wrench, to position the tool to selectively applying torque to the bar. The bar is configured to transfer the torque from the tool to the flange to selectively install the flange on and remove the flange from a threaded pipe.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a flange manipulating device according to an embodiment of the disclosure.

FIG. 2 is a top view of an embodiment of the disclosure.

FIG. 3 is a side view of an embodiment of the disclosure.

FIG. 4 is an in-use view of an embodiment of the disclosure.

FIG. 5 is an in-use view of an embodiment of the disclosure.

### DETAILED DESCRIPTION OF THE INVENTION

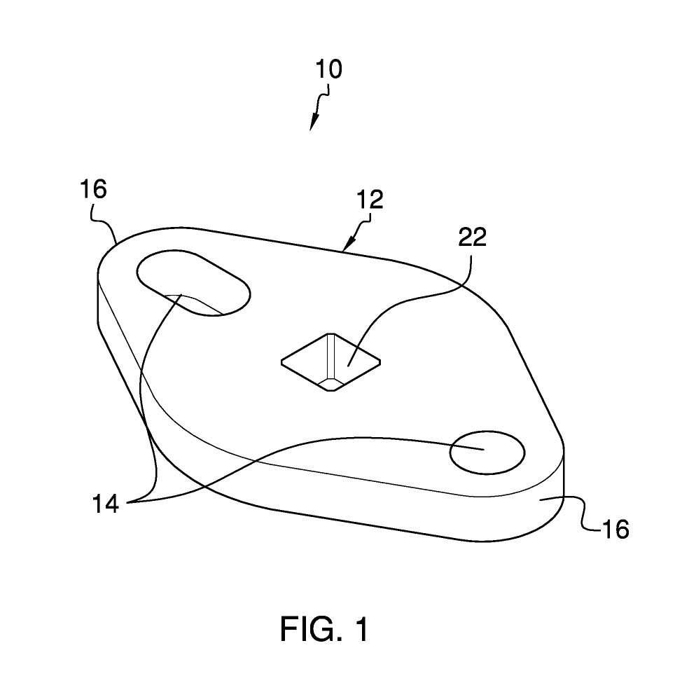

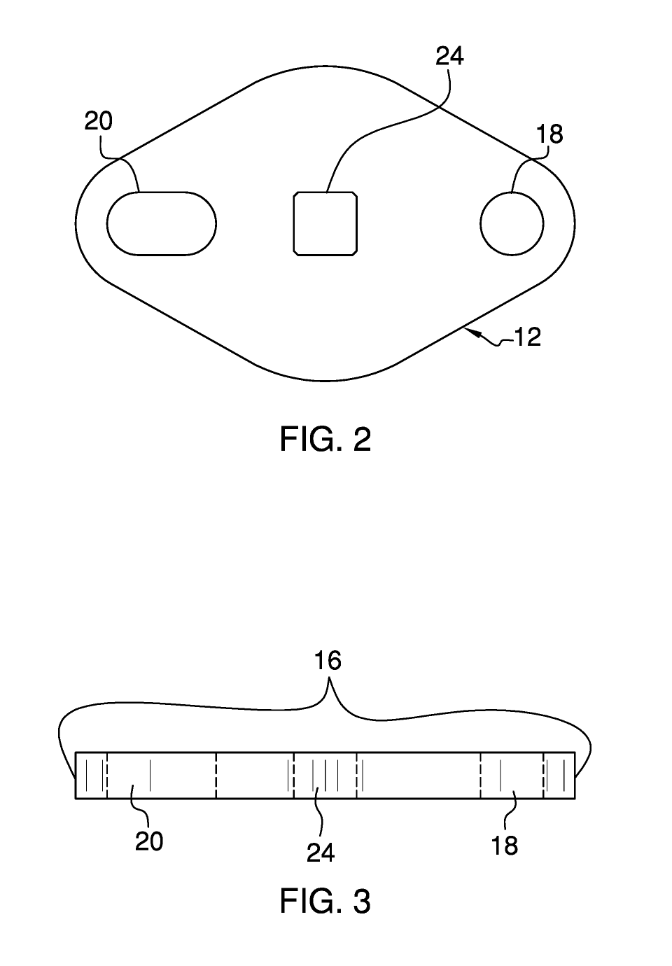

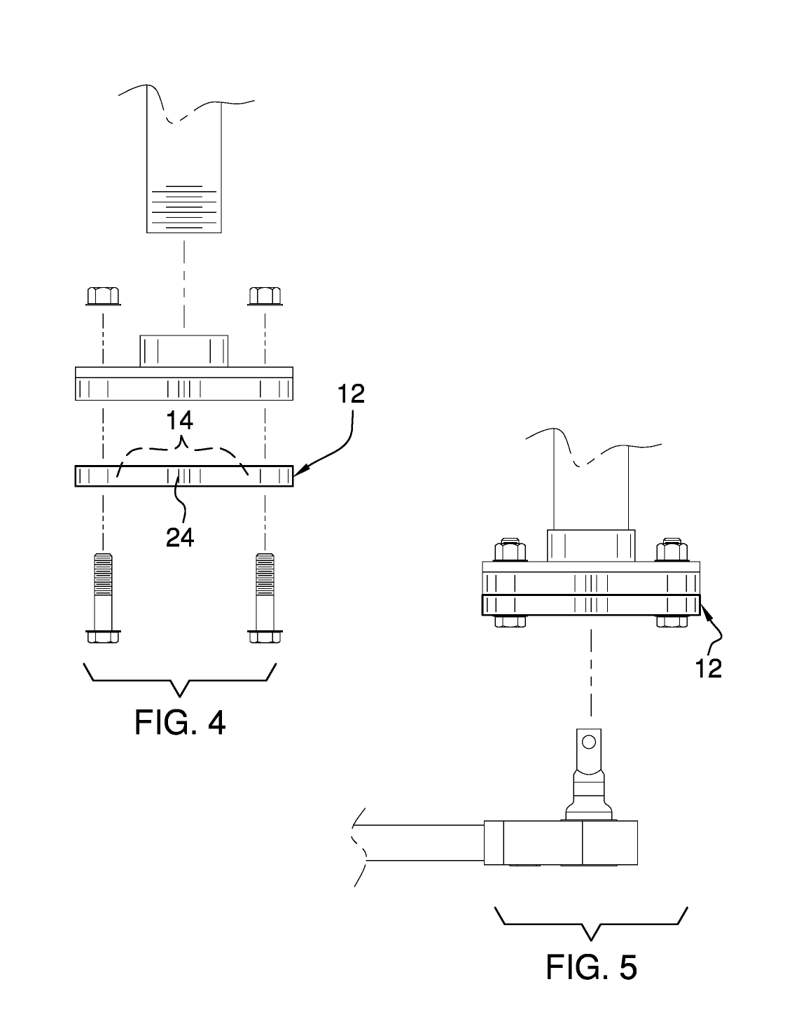

With reference now to the drawings, and in particular to FIGS. 1 through 5 thereof, a new manipulating device embodying the principles and concepts of an embodiment of the disclosure and generally designated by the reference numeral 10 will be described.

As best illustrated in FIGS. 1 through 5, the flange manipulating device 10 generally comprises a bar 12 that is flat. In one embodiment, the bar 12 is substantially elliptically shaped so that the bar 12 is shaped substantially complementarily to a flange. In another embodiment, the bar 12 comprises metal.

A pair of first holes 14 is positioned through the bar 12. Each first hole 14 is positioned proximate to a respective opposing end 16 of the bar 12. Each first hole 14 is configured to selectively align with a respective second hole that is positioned in the flange. The first hole 14 and the respective second hole are configured to insert hardware, such as a bolt to couple to a nut, to couple the bar 12 to the flange.

In one embodiment, the pair of first holes 14 comprises a first orifice 18 and a second orifice 20. The first orifice 18 is circularly shaped. The second orifice 20 is ovally shaped. The pair of first holes 14 is configured to align with pairs of second holes that have a range of separations.

A coupler 22 is coupled to the bar 12. The coupler 22 is centrally positioned on the bar 12. The coupler 22 is configured to couple to a tool, such as a wrench, to position the tool to selectively apply torque to the bar 12. The bar 12 is positioned on the flange so that the bar 12 is configured to transfer the torque from the tool to the flange to selectively install the flange on and to remove the flange from a threaded pipe.

In one embodiment, the coupler 22 comprises a penetration 24 that is positioned through the bar 12. The penetration 24 is squarely shaped. The penetration 24 is configured to insert a square connector of a ratchet wrench to couple the ratchet wrench to the bar 12. The bar 12 is configured to transfer the torque from the ratchet wrench to the flange to selectively install the flange on and to remove the flange from the threaded pipe.

In use, the first orifice 18 and the second orifice 20 are configured to selectively align with the pairs of second holes that are positioned in the flange. The pairs of second holes can have a range of separations. Each first hole 14 and the respective second hole are configured to insert the hardware, such as the bolt to couple to the nut, to couple the bar 12 to the flange. The penetration 24 that is positioned in the bar 12 is configured to insert the square connector of the ratchet wrench to couple the ratchet wrench to the bar 12. The bar 12 is configured to transfer the torque from the ratchet wrench to the flange to selectively install the flange on and to remove the flange from the threaded pipe.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A flange manipulating device comprising:
a bar, said bar being flat;
a pair of first holes positioned through said bar, each said first hole being positioned proximate to a respective opposing end of said bar;
a coupler coupled to said bar, said coupler being centrally positioned on said bar, said coupler being configured for coupling to a tool; and
wherein said first holes are positioned in said bar such that each said first hole is configured for selectively aligning with a respective second hole positioned in the flange such that said first hole and the respective second hole are configured for inserting hardware, such as a bolt for coupling to a nut, for coupling said bar to the flange, wherein said coupler is positioned on said bar such that said coupler is configured for coupling to the tool, such as a wrench, positioning the tool for selectively applying torque to said bar, wherein said bar is positioned on the flange such that said bar is configured for transferring the torque from the tool to the flange for selectively installing the flange on and removing the flange from a threaded pipe.

2. The device of claim 1, further including said bar being substantially elliptically shaped such that said bar is shaped substantially complementarily to a flange.

3. The device of claim 1, further including said bar comprising metal.

4. The device of claim 1, further including said pair of first holes comprising a first orifice and a second orifice, said first orifice being circularly shaped, said second orifice being ovally shaped such that said pair of first holes is configured for aligning with pairs of second holes having a range of separations.

5. The device of claim 1, further including said coupler comprising a penetration positioned through said bar, said penetration being squarely shaped such that said penetration is configured for inserting a square connector of a ratchet wrench for coupling the ratchet wrench to said bar such that said bar is configured for transferring the torque from the ratchet wrench to the flange for selectively installing the flange on and removing the flange from the threaded pipe.

6. A flange manipulating device comprising:
a bar, said bar being flat, said bar being substantially elliptically shaped such that said bar is shaped substantially complementarily to a flange, said bar comprising metal;
a pair of first holes positioned through said bar, each said first hole being positioned proximate to a respective opposing end of said bar, wherein said first holes are positioned in said bar such that each said first hole is configured for selectively aligning with a respective second hole positioned in the flange such that said first hole and the respective second hole are configured for inserting hardware, such as a bolt for coupling to a nut, for coupling said bar to the flange, said pair of first holes comprising a first orifice and a second orifice, said first orifice being circularly shaped, said second orifice being ovally shaped such that said pair of first holes is configured for aligning with pairs of second holes having a range of separations;
a coupler coupled to said bar, said coupler being centrally positioned on said bar, said coupler being configured for coupling to a tool, wherein said coupler is positioned on said bar such that said coupler is configured for coupling to the tool, such as a wrench, positioning the tool for selectively applying torque to said bar, wherein said bar is positioned on the flange such that said bar is configured for transferring the torque from the tool to the flange for selectively installing the flange on and removing the flange from a threaded pipe, said coupler comprising a penetration positioned through said bar, said penetration being squarely shaped such that said penetration is configured for inserting a square connector of a ratchet wrench for coupling the ratchet wrench to said bar such that said bar is configured for transferring the torque from the ratchet wrench to the flange for selectively installing the flange on and removing the flange from the threaded pipe; and
wherein said first orifice and said second orifice are positioned in said bar such that said first orifice and said second orifice are configured for selectively aligning with the pairs of second holes having a range of separations positioned in the flange such that each said first hole and the respective second hole are configured for inserting the hardware, such as the bolt for coupling to the nut, for coupling said bar to the flange, wherein said penetration is positioned in said bar such that said penetration is configured for inserting the square connector of the ratchet wrench for coupling the ratchet wrench to said bar such that said bar is configured for transferring the torque from the ratchet wrench to the flange for selectively installing the flange on and removing the flange from the threaded pipe.
